(19) United States
(12) Patent Application Publication
(10) Pub. No.: US 2005/0014465 A1
(43) Pub. Date: Jan. 20, 2005

(54) Method for information transfer between terminals of a communication network, and program module and terminal for this

(75) Inventors: Stephan Rupp, Besigheim (DE); Franz-Josef Banet, Vaihingen (DE); Uwe Stahl, Leonberg (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/862,530

(22) Filed: Jun. 8, 2004

(30) Foreign Application Priority Data
Jul. 18, 2003 (EP) 03 291 784.1

(51) Int. Cl. H04B 7/15

(52) U.S. Cl. 455/11.1; 455/445

(57) ABSTRACT

The invention relates to a method for information transfer between terminals of a communication network, wherein these terminals each have a data memory for storing addresses and information and means for setting up data connections among themselves, wherein a calling terminal transmits an enquiry for transmission of an item of information to a called terminal, the called terminal reads stored information from a part of the data memory released for the calling terminal and the called terminal uses the received address of the calling terminal to send back a message with the desired information to the calling terminal, and a program module and terminal for this.

### TECHNICAL FIELD

The invention relates to a method for information transfer between terminals of a communication network, wherein these terminals each have a data memory for storing addresses and information and means for setting up data connections among themselves, a program module for execution on a called terminal, which has a data memory and communication means for exchanging data with further terminals, and a terminal with a program module. The invention is based on a priority application 03291784.1 which is hereby incorporated by reference.

### BACKGROUND OF THE INVENTION

For information searches, methods are known on the Internet in which the user, by entering the Internet address of a server of a service provider in his terminal, requests a so-called search mask. Here the user can specify more or less precisely, for example by means of entering search terms or selecting attributes in the search mask, what information he wants to receive. He is then shown a list of relevant entries, for example, from which he can then choose certain entries.

A large number of methods are known for a search for unknown network addresses. The directory assistance service is one conventional method. In this, a telephone terminal is used to establish a telephone connection with a network central station, and the name for which a (network) address is sought is transmitted. By means of a central database, which contains an assignment of name and address data (call number, residential address etc.) for practically all users of a network operator or country, the requested address is found and transmitted to the enquiring terminal. A method for automatic searching for network addresses is offered on the Internet by a large number of information providers for Internet terminals.

However, these methods have the disadvantage that large quantities of data must be kept continually up to date centrally. This represents a major expense in infrastructure on one hand (i.e. large and fast database, sufficiently wide access to this database), and also on the other hand a major maintenance expense (i.e. every address change must be entered without delay).

For the Internet, protocols and mechanisms are known which enable Internet terminals to form a so-called “peer-to-peer” network. In contrast to the server-based information systems mentioned above, in which enquiring terminals or clients are dealing with central servers which give the answer, peer-to-peer networks generally manage without a central service infrastructure (servers or databases). Suitable protocols for this are described in the SUN Microsystems Project JXTA, for instance.

The electronic telephone directory of a telephone terminal is normally in everyday use by every user. In this telephone book it is usually possible to store a certain number of network addresses, i.e. call numbers, names assigned to these addresses, and possibly further information. However, the use of this telephone book is restricted to simplifying communication with known participants, or repeatedly retrieving the information once entered for a name. As soon as information is sought for a name that is not held in this telephone book, or whose assigned information is incomplete, other search methods must be applied.

### SUMMARY OF THE INVENTION

The invention is based on the object of creating a method and suitable means, which enable a decentralized information service to be implemented with the terminals of a communications network alone.

According to the invention this object is achieved by a method for information transfer between terminals of a communication network, wherein these terminals each have a data memory for storing addresses and information and means for setting up data connections among themselves, a program module for execution on a called terminal, which has a data memory and communication means for exchanging data with further terminals, and a terminal with a program module.

The basic idea of the invention is the creation of a peer-to-peer network by the linking of the address directories of the terminals in a communications network, preferably a mobile radio network, which provides for data communication between the terminals. A calling terminal here transmits an enquiry for transmission of an item of information to a called terminal. The called terminal reads information stored in its address directory and released for general viewing by other terminals, and sends back to the calling terminal a message with a desired item of information, or about the desired information.

Further advantageous developments of the invention can be taken from the dependent claims and the description.

### BRIEF DESCRIPTION OF THE DRAWINGS

The invention is further explained hereinafter with the help of the drawings:

FIG. 1 shows schematically a communication relationship between two terminals according to the invention,

FIG. 2 shows examples of communication relationships between terminals according to the invention during the execution of a method according to the invention,

FIG. 3a shows a first specific communication sequence according to FIG. 2,

FIG. 3b shows a second specific communication sequence according to FIG. 2 and

FIG. 4 shows an example of the content and the functional structure of a data entry for a terminal according to the invention.

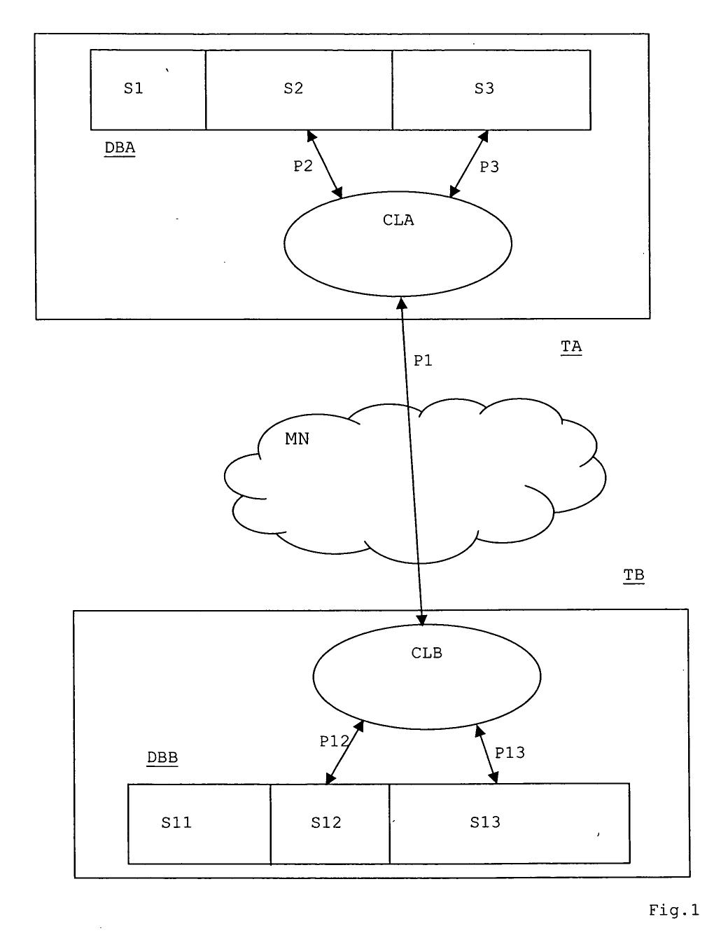

FIG. 1 schematically shows two terminals according to the invention, for example a calling terminal TA and a called terminal TB, which are connected to each other over a mobile communications network MN through an external communication relationship, which is illustrated by a double arrow P1. Each of these terminals TA and TB, also referred to in the following text as peers, has a data memory DBA or DBB respectively, shown here in each case divided into three segments as an example: a private segment S1 or S11 respectively, a limited-access segment S2 or 12 respectively, and a public segment S3 or S13 respectively. Each terminal TA and TB further has an application program CLA or CLB respectively, the first application program CLA accessing the restricted-access segment S2 by means of a first communication connection P2 illustrated by a double arrow, and accessing the public-access segment S3 by means of a second communication connection P3 illustrated by a double arrow. Analogously, the second application program CLB of the called terminal accesses the segments S12 and S13 by means of the internal communication connections P12 and P13 respectively.

The aforementioned peers TA and TB are realized for example with mobile telephones, i.e. terminals of a mobile radio network (e.g. a mobile radio network according to the GSM (Global System for Mobile Communications) standards), on to which mobile telephones corresponding application programs are loaded. Thus for example the Java Micro Edition from the company SUN, which by now is available on many mobile telephones, provides the prerequisite for such a realization. In Java terminology, the generalized term for a mobile telephone of any manufacture is “Mobile Information Device (MID)”. The term “MIDlet” is then understood as an application that is loaded on such a device. The choice of name follows on from the familiar applets (small applications in the browser window) or servlets (server-side applications). On the same lines as this usage, these MIDlets for communication applications are subsequently also referred to as “chatlets”.

The communication elements of the terminals or peers TA and TB form so-called end points in the example. For instance, a first end point is represented by the mobile radio interface (e.g. GSM), and a second end point by a Bluetooth interface of a mobile terminal or mobile telephone. The peer-to-peer connections between the peers involved can be realized by mobile radio connections between mobile radio terminals (e.g. GSM) or also, for example, by Bluetooth or other connections especially of short range.

The chatlet CLA or CLB has access to the address or call directories of the calling terminal TA or the called terminal CLB respectively. When a call number is clicked in the calling terminal TA, this is used by the chatlet CLA analogously to a web address or a so-called Uniform Resource Locator (URL), to gain access to the called terminal TB. These call numbers can be displayed in the display of the terminal TA, made clickable analogously to the URL of the Internet. A clicked call number can then also be referred to as an MRL (Mobile Resource Locator).

For reasons of data protection, it should be possible for the owner to block the access described above to the called terminal TB, or only allow access to a restricted user group. According to the division of the memory DBA and DBB selected in FIG. 1, in each case a first part of the data memory S1 or S11 respectively is entirely blocked for remote access (private sector), a second area S2 or S12 respectively is made accessible only for certain terminals (restricted sector) and a third area S3 or S13 respectively is made generally accessible (public sector).

The chatlet CLA or CLB itself is, as described above, an application program, which runs within the Java runtime environment of the mobile telephone, for example. The most important part of the chatlet is the so-called “user instances”. User instances are nothing more than a generalisation of the entries in the mobile telephone's name list. The name list includes at least the name and telephone number for each entry. But the entries can also contain a complete business card, i.e. all possible private and business telephone numbers, fax, email, address and some keywords. The entries can be made individually by the users. These entries can also be exchanged with other users, i.e. entries in the called terminal TB can be transferred to the calling terminal TA.

When an entry is selected from the name list, the chatlet CLA of the calling terminal TA generates an enquiry, which is transmitted to the chatlet CLB of the called terminal. The chatlet CLB of the called terminal creates a copy of the desired data, for example the data available about a user, in the working memory of terminal TB. In addition to the attributes of a business card such as name and telephone numbers, this user instance contains further attributes such as the available icons or images for the telephone service mentioned above, or information such as hobbies or interests, which the user wishes to communicate publicly or among his acquaintances. As well as the attributes, the user instances also contain operations or methods, which the chatlet CLA or CLB can call up, e.g. for access to the name list in the entered user's mobile telephone. Entries may be incomplete (e.g. only some telephone numbers, nothing else).

Attributes and/or methods are generated by the respective users themselves, and can be restricted in terms of public visibility. Publicly visible attributes and methods, i.e. attributes visible to and methods selectable by the chatlet CLA of a calling terminal TA, are declared as “public”, while other attributes and methods visible only to a defined user group are called “private”.

Information on knowledge and skills that the peer wants to make available to its environment can be kept stored in so-called advertisements. These advertisements can either be requested by other peers or can be sent to specific terminals (subscribers). Offers from one peer to another include for example services, application programs and content. What the peer knows about its environment (e.g. knowledge of other peers), it stores for example in its local cache (e.g. information, documents).

An enquiry for transmission of an item of information can contain a search term or a category. A corresponding message with the desired information then contains only information relating to those information entries which contain a matching search term or are assigned to a matching category. It can be provided, for example, that a message is only created when at least one entry has matching search terms or is assigned to matching categories.

The chatlets in the terminals TA and TB are permitted reciprocal access to each other as described above. This enables an information network to be generated in any desired size, with a large but distributed quantity of up-to-date information. For the user of a terminal TA, this information network is presented as though he has stored all this information on his terminal TA, i.e. the structure of the network with its active terminals remains largely transparent for the user.

The possibility of exchanging entries automatically with one another can result in an adaptive network. New telephone numbers are automatically circulated after a relocation or change of provider. People who receive and welcome enquiries are represented in many user instances. In the overall sense, the role of the chatlets here is to provide suitable contact addresses for the desired call partner. Presentation services help to present the call partner's accessibility, and the useful contact options are supplied for activation at the touch of a button.

The connection set-up itself can be carried out in the conventional way, as offered by the networks in which the method according to the invention should be applied. This includes the provision of suitable codecs and the transcoding, and usually also the control flow for the setting up and release of connections, e.g. in a three-way conversation.

Alternatively, it would also be possible for a chatlet to take over the control flow and the selection of the codecs. In this case the networks are then restricted to the provision of addresses and transport channels.

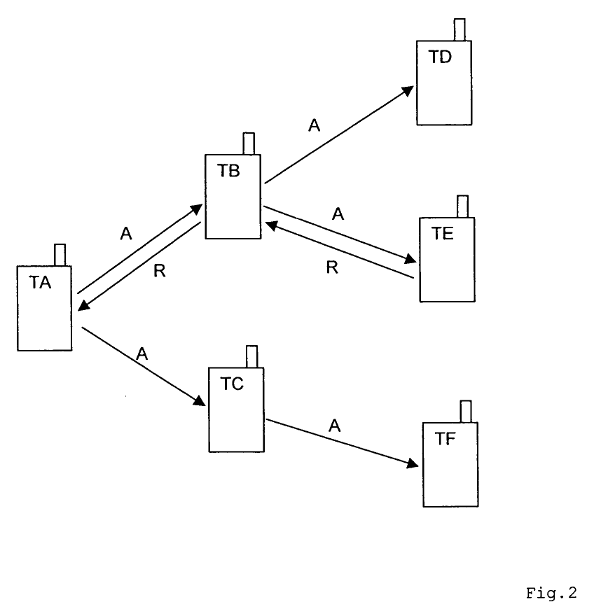

FIG. 2 shows an example of a communication relationship between terminals according to the invention for executing an information search service, in which the calling terminal has no knowledge of which terminal is storing an item of information that is being sought.

For this, FIG. 2 shows a calling terminal, for example the calling terminal TA from FIG. 1, the called terminal TB from FIG. 1 and further called terminals TC-TF. From the calling terminal TA to each of the called terminals TB and TC, from the terminal TB to each of the terminals TD and TE and from the terminal TC to the terminal TF, an arrow A is drawn representing an enquiry for the transmission of certain information. From the terminal TE to the terminal TB and from this terminal to the calling terminal TA, an arrow R is drawn in each case, representing a message with a reply to this enquiry.

The search for the address of a participant in a call is described here as an example. If this address is stored in the data memory of the terminal TA which is initiating the search or calling, the information in question can be produced immediately by chatlet CLA of this terminal TA, and for example displayed directly on this terminal's display. In the event that the desired call partner cannot be found in the terminal's own user instances, the chatlet of the calling terminal TA contacts those terminals whose instances permit access to their respective telephone directories, in this example the terminals TB and TC. If the desired call partner is found in one of these terminals, the corresponding chatlet can contact him or generate in its own directory a copy of the user instance it has found. This latter case corresponds to the exchange of a business card in the user directory.

If the desired call partner is not found in the directories of the queried terminals TB and TC, the transaction can escalate further from the queried user instances, in this example from the terminal TB to terminals TD and TE, and from the terminal TC to the terminal TF. For example, if the terminal TE has stored the address being searched for, a corresponding message R is transmitted from there either via the terminal TB in the enquiry chain, or directly to the calling terminal TA.

The number of required escalation levels is always clearly limited. If 100 new partners are queried in each escalation level, 10 billion users are already reached with 5 levels: (10²)⁵. But this would also be the worst case. In reality, the search is much more effective, as relationship sets are queried as a result of the chained directories. An engineer will usually find a specialist in his own field or a related one more easily than from a completely different sector or an area that has never interested him. His personal telephone directory and those of his acquaintances will ensure this.

A further possibility is to store offers from a number of users in a rendezvous peer, for example in the terminal TB as in FIG. 2. A calling terminal TA can thus first call a terminal TB known to it, in order to reach further terminals TD and TE from there to obtain certain information.

In order to ensure the effectiveness of the method described under FIG. 2, it must be ensured that enquiries cannot propagate explosively and over indefinite periods of time in the communications network. The following measures are possible for this:

Each enquiry is given a time stamp, and there is then a check in the called terminals TB, TC, TD, TE, TF on whether a specific interval of time is exceeded; this enquiry is only pursued if this interval is not yet exceeded.

To prevent enquiries from a distant terminal in an enquiry chain from being transmitted again to a closer terminal (circular reasoning), the address of each terminal over which the enquiry passes can be added to the enquiry, without deleting previous sender addresses. Thus the enquiry received by the terminal TD would for example contain the addresses of the preceding terminals TB and TA in the enquiry chain. When this enquiry is retransmitted, all those terminals whose addresses are already contained in the enquiries can then be excluded.

The communication relationships between the chatlets of terminals involved as an example in a method described under FIG. 2 will now be presented in detail.

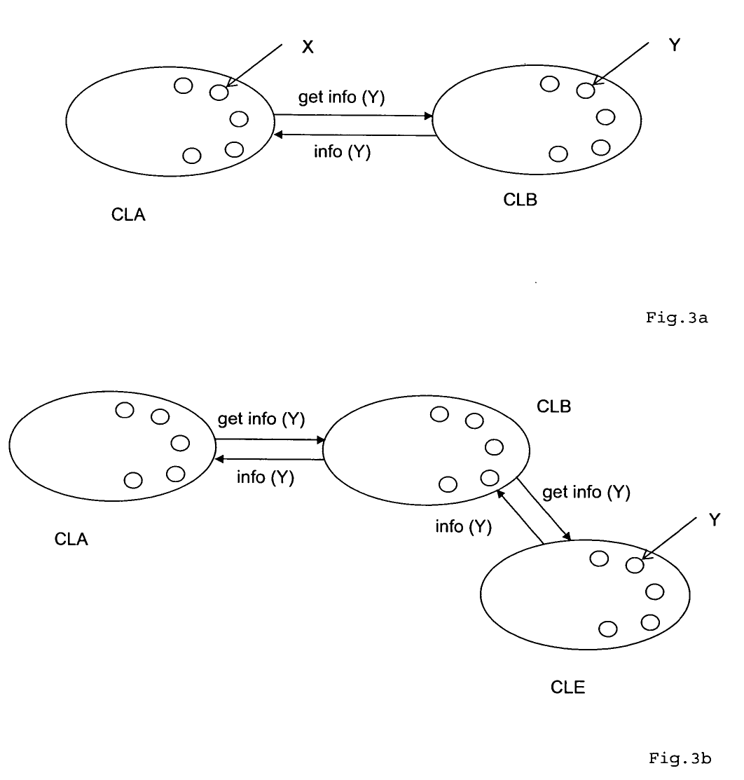

For this, FIG. 3a shows a communication relationship between two chatlets, when the information wanted by the calling terminal is available in the terminal of the immediately called terminal, and FIG. 3b shows a communication relationship between three chatlets, when the information wanted by the calling terminal is not available in the terminal of the immediately called terminal, but only in a further terminal called by this called terminal.

FIG. 3a shows as an example the chatlet CLA of a calling terminal (subsequently also referred to as the calling chatlet CLA), and the chatlet CLB of a called terminal (subsequently also referred to as the called chatlet CLB). The calling chatlet CLA has a number of user entries, of which one user entry X, i.e. an entry about a user X, is labelled as an example. The called chatlet CLB likewise has a number of user entries, of which one user entry Y, i.e. an entry about a user Y, is labelled as an example. An enquiry from the calling chatlet CLA to the called chatlet CLB for information about the user Y is represented by an arrow labelled get info (Y), and a message with the requested information from the called chatlet CLB to the calling chatlet CLA about the user Y is represented by an arrow labelled info (Y).

The communication sequence for the following example scenario is thus represented here:
A user inputs the name of the user Y into the calling terminal.
The calling chatlet CLA checks whether entries, in particular the address, are stored under this name, and sends the enquiry for information about the user Y, get info Y, to the chatlet of one or more terminals, in this example to the called chatlet CLB of a terminal.
The called chatlet CLB checks and finds that the entry looked for, in particular the address of the user Y, is present, and that the calling user is authorized to receive this information, and sends a message with this information, info Y, to the calling chatlet.

In accordance with Java terminology, get info (Y) can be called a method here, and info (Y) an attribute:

get_info (Y): Call of the information stored about the user Y, for example about opening times, surgery hours, on-call service etc. This information is transferred to the calling terminal's mobile telephone. If applicable, further selections can be made there (e.g. display of the nearest chemist in the on-call service).

info (Y): an address field, e.g. for the postal address, opening times, surgery hours, on-call service of user Y.

FIG. 3b shows as an example the calling chatlet CLA, and the called chatlet CLB from FIG. 3a and a further chatlet CLE called by the called chatlet CLB. The chatlets CLA, CLB and CLE each have a number of user entries. In contrast to FIG. 3a, it is assumed here that the user information about the user Y is stored not in the called chatlet CLB, but in the further called chatlet CLE. The enquiry from the calling chatlet CLA to the called chatlet CLB is represented as in FIG. 3a by the arrow labelled get info (Y). Unlike FIG. 3a, in this case the enquiry is relayed to the further called chatlet E, this communication being represented here by an arrow likewise labelled info (Y) from the called chatlet CLB to the further called chatlet CLE. A message with the requested information, represented as in FIG. 3a in each case by an arrow labelled info (Y), leads from the further called chatlet CLE to the called chatlet CLB and from there to the calling chatlet CLA.

The communication sequence for the following example scenario, expanded in comparison to FIG. 3a, is represented here:
A user inputs the name of the user Y into the calling terminal.
The calling chatlet CLA checks whether entries, in particular the address, are stored under this name, and sends the enquiry for information about the user Y, get info Y, to the chatlet of one or more terminals, in this example to the called chatlet CLB of a terminal.
The called chatlet CLB checks and finds that the entry looked for, in particular the address of the user Y, is not present, and forwards this enquiry to one or more terminals whose addresses are stored in the data memory, in this example to the further called chatlet E.
This chatlet CLE checks and finds that the entry looked for, in particular the address of the user Y, is present, and that the calling user (chatlet A) and/or the intermediate chatlet B is authorized to receive this information, and sends a message with this information, info Y, to the called chatlet B.
The called chatlet CLB transmits this message info y to the calling chatlet A.

As an alternative to this scenario, the further called chatlet E can also transmit the information directly to the calling chatlet A. For this, the address of the calling terminal must be entered into a control field of the enquiry get info (Y).

As described above, it is advantageous if every terminal adds its address when forwarding an enquiry. A further called terminal can then always find out which terminals have already received this enquiry, and suppress forwarding of this enquiry to these terminals.

In a further alternative, the called terminal TB or the further called terminal TE can have stored an assignment of search terms or categories and addresses of further terminals. The enquiry can then contain one or more search terms and/or categories instead of a specific name, for instance. The called terminal then forwards this enquiry only to such further terminals as contain the search term(s) or are assigned to the categories.

An advantageous development of the method according to the invention enables a creation of location-based services which can be made available by the service-providing terminal users themselves without intermediary service providers. Cost-saving solutions can thereby be developed, as no central maintenance of data is required. Furthermore, this method offers the users the advantage of ease of operation and good transparency.

This local information is not maintained on a (central) server, like services with central administration, but directly in the mobile telephones of those persons who want to offer location-based services (i.e. directly in the mobile telephone of the driver for a taxi firm, for example). The data is either imported automatically, for example in a cyclic update or an update on retrieval of the local information by the mobile telephone, or is entered in the mobile telephone by the person offering the service (e.g. static local information about the residence or place of business). This information can be queried by customers of the service.

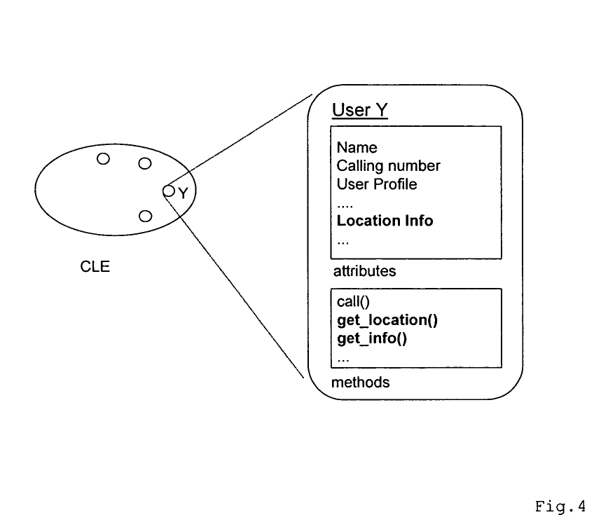

FIG. 4 shows an example of layout for a user entry.

FIG. 4 shows as an example the chatlet CLE of the further called terminal TE from FIG. 2 with stored user instances or user entries. The user entry of a user Y is shown as an example. As examples of attributes, this entry contains the name, the call number or address (Calling number), a profile (user profile) and local information (Location Info). As methods, this entry contains a call for transmission of information (get_info( )) and a call for transmission of local information (get_location( )).

Within the user entry about the user Y of the chatlet, there is the following attribute here in addition to the attribute Info( ) described above:

Location: current local information (e.g. geographical coordinates) for the user's mobile telephone. An update of the local information from the network with which the user is registered (Location Update), occurs on the mobile telephone of the queried user, e.g. on retrieval of the method “get_location( )” by another user.

Within the user entries of the chatlets there are location-based services in addition to the method get info ( ) described above, the following additional method:

get_location( ): Call of the current coordinates of the mobile telephone of the called user. This information is transferred to the mobile telephone of the enquiring user, and can be further evaluated there (e.g. in the search for the geographically nearest taxi driver)

At the click of a button or by clicking an icon, a telephone contact can thus be made without telephone numbers or a switching service, if the called terminal is in the selected local area. Possible applications for this are, for example: Taxi calls, doctors' on-call service, specialists in the area and their surgery hours, chemists' availability duty, authorities' opening times and contact persons, so-called blind dates, virtual meetings for special interests in the vicinity.

1. A method for information transfer between terminals of a communication network, wherein these terminals each have a data memory for storing addresses and information and means for setting up data connections among themselves, wherein
a calling terminal transmits an enquiry for transmission of an item of information to a called terminal,
the called terminal reads stored information from a part of the data memory released for the calling terminal and
the called terminal uses the received address of the calling terminal to send back a message with the desired information to the calling terminal.

2. Method according to claim 1, wherein the message with the desired information contains both attributes, in particular information about a user, and also methods, with which the calling terminal can be accessed.

3. Method according to claim 1, wherein the enquiry for transmission of an item of information contains a search term or a category, and that the message with the desired information contains only information relating to those information entries which contain a matching search term or are assigned to a matching category.

4. Method according to claim 2, wherein the called terminal has stored an assignment of search terms or categories and addresses of further terminals, and that the called terminal forwards this enquiry to such further terminals as are assigned to this search term or category.

5. Method according to claim 3, wherein the called terminal returns a message with the desired information to the calling terminal if this information is stored in the data memory of the called terminal, and if this information is not stored there, forwards this enquiry to at least one further terminal of those terminals whose addresses are stored in the data memory of the called terminal.

6. Method according to claim 4, wherein the enquiry contains a time stamp, and that there is a check in the called terminal on whether a certain interval of time is exceeded, and this enquiry is only pursued if this interval is not yet exceeded.

7. Method according to claim 1, wherein after clicking on an address shown in the display of the calling terminal, the enquiry for transmission of the information is automatically created and transmitted to the called terminal.

8. Method according to claim 1, wherein the data memory of the called terminal has a restricted released area and an unrestricted released area, that the called terminal has stored a list with the call numbers or addresses of those terminals who are granted access to information in the restricted released area, and that the called terminal only returns an answer with information that is stored in the restricted released area if the call number of the calling terminal is stored in this list.

9. Method according to claim 1, wherein the enquiry has a location stamp, that the called terminal receives information about its current location or presence in a specific local area, and this enquiry is only pursued by the called terminal if the location stamp indicates a location within a specific radius of the current location or a location within the specific local area.

10. Method according to claim 1, wherein information stored in the data memory is marked with a retention period, and is automatically deleted after expiry of this retention period.

11. Program module for execution on a called terminal, which has a data memory and communication means for exchanging data with further terminals, wherein the following functions are performed:
Receiving an enquiry from a calling terminal for transmission of a message with an item of information stored in the data memory,
Checking whether a message with a corresponding answer can be created with the information stored in the data memory,
Creation of an answer, if this message can be created, and transmission to the calling terminal.

12. Terminal with a program module according to claim 11.
